(19) United States
(12) Patent Application Publication
(10) Pub. No.: US 2009/0157891 A1
(43) Pub. Date: Jun. 18, 2009

(54) Method and Apparatus for Inserting Time-Variant Data into a Media Stream

(75) Inventor: Gary Hughes, Chelmsford, MA (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 11/955,896

(22) Filed: Dec. 13, 2007

(51) Int. Cl. G06F 15/16

(52) U.S. Cl. 709/231

(57) ABSTRACT

An on-demand streaming server includes a memory array for storing on-demand content. The streaming server also includes at least one stream server module for retrieving the content from the memory array and generating therefrom a plurality of asynchronous media streams to be transmitted to client devices in accordance with a first transport protocol stack during an on-demand session. The stream server module includes a processor for interleaving into at least one of the asynchronous media streams a secondary data stream in accordance with the first transport protocol stack during the on-demand session.

### FIELD OF THE INVENTION

The present invention relates to a method and system for managing and controlling streaming by an on-demand streaming server, and more particularly to a method and system for streaming to client devices both the on-demand content and other data.

### BACKGROUND OF THE INVENTION

On-demand services such as a video on-demand (VOD), television on-demand (TOD), subscription video on-demand (SVOD), switched digital video (SDV) are rapidly growing as ways to provide enhanced viewing experiences to subscribers. For instance, a video on-demand service permits a viewer to order a movie or other video program material for immediate viewing. In a typical broadcast satellite or cable television (CATV) system, the viewer is presented with a library of video choices. The VOD program material, such as for example movies, are referred to herein as assets, programs or content. The viewer may be able to search for desired content by sorting the library according to actor, title, genre or other criteria before making a selection. In general, assets, programs and content include audio files, images and/or text as well as video.

In a typical on-demand system, an application software component (known as the on-demand client) resides in the CATV set-top box (STB) at the viewer's home. A typical on-demand system further includes an on-demand streaming server, which is a memory intensive system that stores content at the headend and generates the video stream for each subscriber. In the case of VOD, the video inventory in the streaming server may contain thousands of titles. The on-demand streaming server further generates one VOD video stream for each active VOD viewer. There may be thousands of simultaneous active VOD viewers. A typical on-demand system includes an on-demand asset management system, a resource management system, an on-demand business management system and a conditional access system.

The on-demand streaming server is designed to stream as much content as possible to as many users as possible, from as small a space as possible. The main areas of functionality required to deliver the on-demand services in a pre-existing network or distribution system are: on-demand server provisioning, content ingest management, session setup/stream management, and on-demand service assurance. Moreover, the on-demand streaming server should be able to simultaneously ingest, store and stream the content in real time. In contrast to an on-demand streaming server, conventional video servers typically can only perform one of these functions at a time.

The system implementing on-demand services often provides the capability to limit content access to authorized subscribers only, as the contents delivered as part of the service are generally considered valuable intellectual properties by their owners. In cable and satellite television, such capability is known as conditional access. Conditional access requires a trustworthy mechanism for classifying subscribers into different classes, and an enforcement mechanism for denying access to unauthorized subscribers. Encryption is typically the mechanism used to deny unauthorized access to content (as opposed to denying access to the carrier signal).

To use conditional access with on-demand systems, the content may be pre-encrypted before it is stored on the video server. Pre-encryption requires preprocessing content as it is transferred from the content owner to the cable operator. In addition, the management and distribution of cable system-specific cryptographic parameters (e.g., encryption keys) is often also required as part of a VOD session, possibly requiring the use of an Encryption Renewal System. Such cryptographic parameters may be periodical keys that must be periodically sent to an authorized subscriber's set top terminal to decrypt the content. The periodical keys may be included in Encryption Control Messages (ECMs) that are sent to the subscriber on a regular or periodic basis. That is, both the pre-encrypted content and the ECMs need to be streamed to the subscriber's set top terminal.

If the ECMs were time-invariant, they could be incorporated with the content during the ingestion process. However, since the content of the ECMs generally vary with time, they must be provided in a separate stream along with the content in real time as the content is being streamed during a playout session. This can be difficult to accomplish because on-demand streaming servers generally store media streams in a format close to the final streaming format so that they can be streamed with minimal changes.

### BRIEF DESCRIPTION OF THE DRAWINGS

FIG. 1 shows one example of an on-demand streaming server.

FIG. 2 shows a block diagram of one example of the stream server modules shown in FIG. 1.

FIG. 3 shows one example of a process by which a streaming server can stream both on-demand content requested by a subscriber along with other data such as time-variant or session-variant data.

### DETAILED DESCRIPTION

An on-demand streaming server streams content and time-variant data such as ECMs to a set top terminal by interleaving the time-variant data as a low bit rate data stream onto the media stream. The time-variant data can be incorporated in MPEG transport packets or the like, which are then further packetized using the same protocol stacks used to packetize the on-demand content. In addition to ECMs, other examples of time-variant data that may be interleaved with the media stream include, for example, without limitation, encryption control messages, session or content identification messages, and system status or heartbeat messages. For purposes of clarity, the media stream that includes the on-demand content will be referred to from time-to-time as the primary stream and the media stream that includes secondary data (e.g., ECMs or other time-variant or session variant data) may be referred to as the secondary stream.

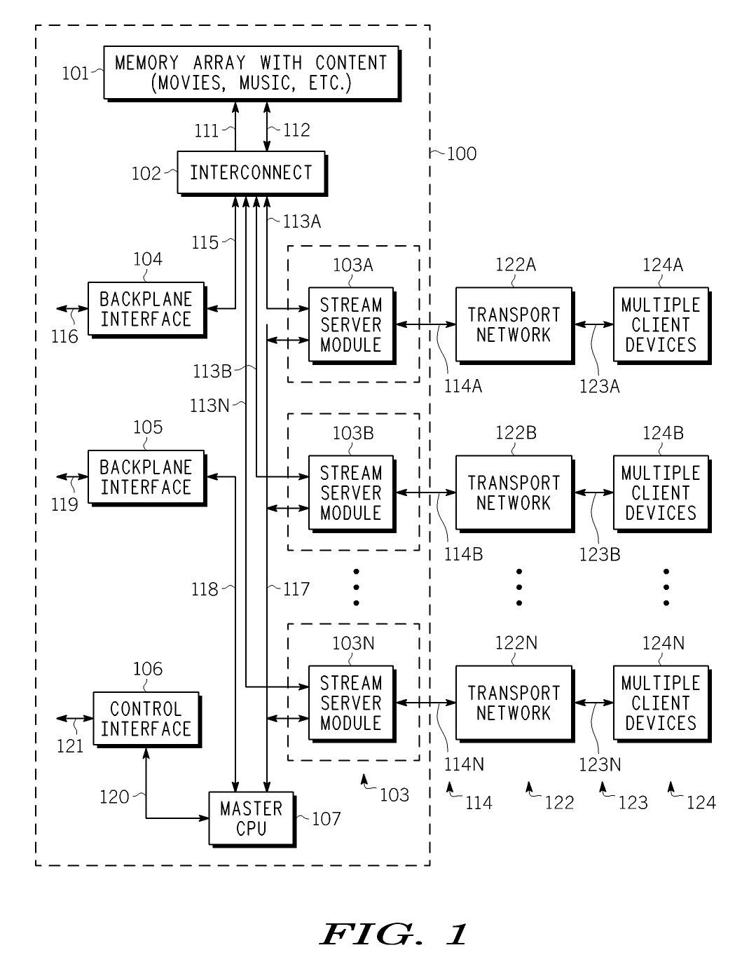

One example of an on-demand streaming server 100 that may employ the methods, techniques and systems described herein is shown in FIG. 1. While the server 100 will be used for purposes of illustration, those of ordinary skill in the art will recognize that the methods, techniques and systems described herein are also applicable to wide variety of the other on-demand streaming servers employing different architectures.

As seen in FIG. 1, the streaming server 100 is part of a communication system that also includes transport networks 122a through 122n (122), and client devices 124a through 124n (124). In a typical system, each client device would operate through a single transport network, but each transport network could communicate with the server system 100 through any of the stream server modules. Each transport network can operate using a different protocol, such as IP (Internet Protocol), ATM (Asynchronous Transfer Mode), Ethernet, or other suitable Layer-2 or Layer-3 protocols. In addition, a specific transport network can operate with multiple upper-level protocols such as Quick Time, Real Networks, RTP (Real Time Protocol), RTSP (Real Time Streaming Protocol), UDP (User Datagram Protocol), TCP (Transport Control Protocol), etc. A typical example would be an Ethernet transport network with IP protocol packets that contain UDP packets, which in turn contain RTP payload packets. The payload packets contain the on-demand content, which is digitally encoded in a suitable format such as MPEG.

The on-demand streaming server 100 includes a memory array 101, an interconnect device 102, and stream server modules 103a through 103n (103). Memory array 101 is used to store the on-demand content and could be many Gigabytes or Terabytes in size. Such memory arrays may be built from conventional memory solid state memory including, but not limited to, dynamic random access memory (DRAM) and synchronous DRAM (SDRAM). The stream server modules 103 retrieve the content from the memory array 101 and generate multiple asynchronous streams of data that can be transmitted to the client devices. The interconnect 102 controls the transfer of data between the memory array 101 and the stream server modules 103. The interconnect 102 also establishes priority among the stream server modules 103, determining the order in which the stream server modules receive data from the memory array 101.

The communication process starts with a stream request being sent from a client device 124 over an associated transport network 122. The command for the request arrives over a signal line 114a-114n (114) to a stream server module 103, where the protocol information is decoded. If the request comes in from stream server module 103a, for example, it travels over a bus 117 to a master CPU 107. For local configuration and status updates, the CPU 107 is also connected to a local control interface 106 over signal line 120, which communicates with the system operator over a line 121. Typically this could be a terminal or local computer using a serial connection or network connection.

Control functions, or non-streaming payloads, are handled by the master CPU 107. Program instructions in the master CPU 107 determine the location of the desired content or program material in memory array 101. The memory array 101 is a large scale memory buffer that can store video, audio and other information. In this manner, the server system 100 can provide a variety of content to multiple customer devices simultaneously. Each customer device can receive the same content or different content. The content provided to each customer is transmitted as a unique asynchronous media stream of data that may or may not coincide in time with the unique asynchronous media streams sent to other customer devices.

If the requested content is not already resident in the memory array 101, a request to load the program is issued over signal line 118, through a backplane interface 105 and over a signal line 119. An external processor or CPU (not shown) responds to the request by loading the requested program content over a backplane line 116, under the control of backplane interface 104. Backplane interface 104 is connected to the memory array 101 through the interconnect 102. This allows the memory array 101 to be shared by the stream server modules 103, as well as the backplane interface 104. The program content is written from the backplane interface 104, sent over signal line 115, through interconnect 102, over signal line 112, and finally to the memory array 101.

When the first block of program material has been loaded into memory array 101, the streaming output can begin. Streaming output can also be delayed until the entire program has been loaded into memory array 101, or at any point in between. Data playback is controlled by a selected one or more stream server modules 103. If the stream server module 103a is selected, for example, the stream server module 103a sends read requests over signal line 113a, through the interconnect 102, over a signal line 111 to the memory array 101. A block of data is read from the memory array 101, sent over signal line 112, through the interconnect 102, and over signal line 113a to the stream server module 103a. Once the block of data has arrived at the stream server module 103a, the transport protocol stack is generated for this block and the resulting primary media stream is sent to transport network 122a over signal line 114a. Transport network 122a then carries the primary media stream to the client device 124a over signal line 123a. This process is repeated for each data block contained in the program source material.

If the requested program content already resides in the memory array 101, the CPU 107 informs the stream server module 103a of the actual location in the memory array. With this information, the stream server module can begin requesting the program stream from memory array 101 immediately.

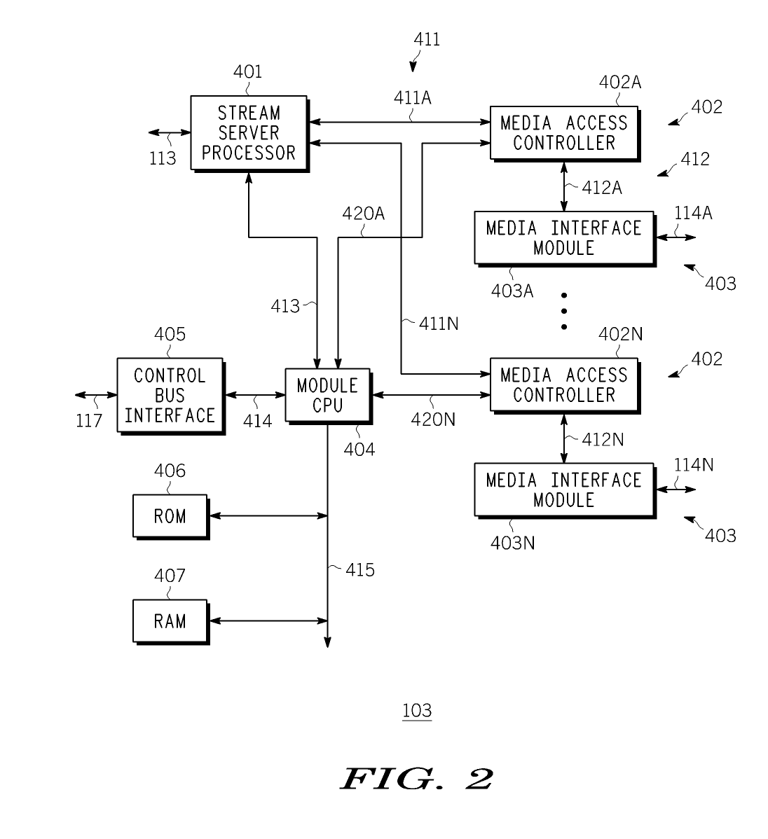

FIG. 2 is a block diagram of one illustrative implementation of the stream server modules 103 shown in FIG. 1. A stream server processor (SSP) 401 serves as the automatic payload requester, as well as the protocol encoder and decoder. The SSP 401 requests and receives data payload over signal line 113. It then encodes and forms network level packets, such as TCP/IP or UDP/IP or the like. The encoded packets are sent out over signal lines 411a-411n (411) to one or more media access controllers (MAC) 402a-402n (402). The media access controllers 402 generate the primary media stream by encapsulating the encoded packets in data link level frames or datagrams as required by the specific physical network used. In the case of Ethernet, for example, the Media Access Controllers 402 also handle the detection of collisions and the auto-recovery of link-level network errors.

The media access controllers 402 are connected utilizing signal lines 412a-412n (412), to media interface modules 403a-403n (403), which are responsible for the physical media of the network connection. This could be a twisted-pair transceiver for Ethernet, Fiber-Optic interface for Ethernet, SONET or many other suitable physical interfaces, which exist now or will be created in the future, such interfaces being appropriate for the physical low-level interface of the desired network. The media interface modules 403 then send the primary media streams over the signal lines 114a-114n (114) to the appropriate client device or devices.

In practice, the stream server processor 401 divides the input and output packets depending on their function. If the packet is an outgoing payload packet, it can be generated directly in the stream server processor (SSP) 401. The SSP 401 then sends the packet to MAC 402a, for example, over signal line 411a. The MAC 402a then uses the media interface module 403a and signal line 412a to send the packet as part of the primary stream to the network over signal line 114a.

Client control requests are received over network line 114a by the media interface module 403a, signal line 412a and MAC 402a. The MAC 402a then sends the request to the SSP 401. The SSP 401 then separates the control packets and forwards them to the module CPU 404 over the signal line 413. The module CPU 404 then utilizes a stored program in ROM/Flash ROM 406, or the like, to process the control packet. For program execution and storing local variables, it is typical to include some working RAM 407. The ROM 406 and RAM 407 are connected to the CPU over local bus 415, which is usually directly connected to the CPU 404.

The module CPU 404 from each stream server module uses signal line 414, control bus interface 405, and bus signal line 117 to forward requests for program content and related system control functions to the master CPU 107 in FIG. 1. By placing a module CPU 404 in each stream server module, the task of session management and session control can be handled close to the network lines 114a-114n. This distributes the CPU load and allows a much greater number of simultaneous stream connections per network interface.

When a secondary stream that includes secondary data is to be interleaved with the primary stream that includes the on-demand content, the secondary data is supplied to the streaming server 100 through backplane interface 104 (see FIG. 1). Interconnect 102 then routes the data to the appropriate stream server module 103, which stores the data in RAM 407. The module CPU 404 receives the data over signal line 415 and encodes and forms the data in network level packets such as such as TCP/IP or UDP/IP packets or the like. The encoding process performed by the module CPU 404 encodes the data in the same format used to encode the on-demand content in the primary media stream. For example, both the on-demand content and the secondary data may be encoded in MPEG transport packets. In this example each network level packet may include one or more MPEG transport packets. For instance, in some cases each network packet may include up to seven MPEG transport packets in which the time-variant data can be incorporated.

The encoded packets are periodically sent out by the module CPU 404 over signal lines 420a-420n (420), to one or more of the media access controllers (MAC) 402a-402n (402). The periodicity at which the encoded packets are sent will generally be determined at the time the on-demand session is initiated and, in the case of ECM messages, may be dictated by how often the periodical keys need to be transmitted to the client device. In some typical cases the ECM messages need to be transmitted on the order of one per second. Other time-variant data may be interleaved at a rate consistent with the time-period over which the data varies.

The encoded packets received by the MACs 402a-402n are then encapsulated in data link level frames or datagrams as required by the specific physical network used. The MACs 402a-402n then forward the datagrams to the media interface modules 403a-403n, which interleaves the datagrams with the datagrams encapsulating the network level packets received from the stream service processor 401. That is, the datagrams in the secondary data stream are interleaved with the datagrams in the primary media stream.

Because the stream server processor 401 is in communication with the module CPU 404 over line 413, the data in the secondary stream can be dependent upon the location at which the secondary data is to be interleaved into the primary stream and/or the current state of the primary stream.

When the content in the primary stream is initially ingested, the streaming server determines the bitrate that the content requires. Such streams require a constant bitrate. In order to schedule datagrams for transmission to the client devices, the available bandwidth is divided into transmit slots (e.g., 1000 slots per second). When a session is established to play out the content, sufficient transmit slots are reserved to meet the bandwidth requirements of the content, lets say 5. These 5 slots are allocated so they are equally spaced through the 1000 slots that represent 1 second of time. When a network output port is active its scheduler periodically (in this example every 1 msec) examines each slot, and if it is assigned to a stream, it checks the primary stream's buffer to see if a datagram is ready to be transmitted transmit. If it is, the datagram is transmitted and the scheduler examines the next slot. When it reaches the end of the list of slots the scheduler loops back to the beginning and starts over. If the slot is not allocated or there is no datagram from the primary stream that is ready to be allocated, the scheduler examines a queue of “opportunistic” datagrams (i.e., datagrams in the secondary stream) that have been queued for transmission on a best effort basis. If this queue in non-empty, the scheduler removes the datagram at the front of the queue and transmits it. If the queue is empty, the scheduler waits until the 1 msec interval is over and examines the next slot in the list. In summary, datagrams from the primary stream have priority in that they are always sent, at the prescribed rate, if they are ready. The time-variant datagrams from the secondary stream are sent on a best effort basis, with the pacing determined by how often a new time-variant datagram is created and queued for transmission. System software is responsible for ensuring that some number of transmit slots are kept available for opportunistic datagrams.

The client devices 124 receive a single media stream that includes both the primary stream and the secondary stream. The datagrams in each stream will appear to be indistinguishable from one another. That is, the client device receives link level (e.g., Ethernet) datagrams that appear to originate from a single source. Since the path used to deliver the primary stream is not directly involved in sending the secondary stream, the critical timing relationships and other control information contained within the primary stream are not affected by the secondary stream. For instance, in the case of an MPEG stream, the various timestamps, and reference clocks such as the Program Clock Reference (PCR), Decode Time Stamp (DTS), and the Presentation Time Stamp (PTS) included in the primary stream are not altered by the presence of the secondary stream. In this way the primary stream can still be properly decoded and presented by the client device.

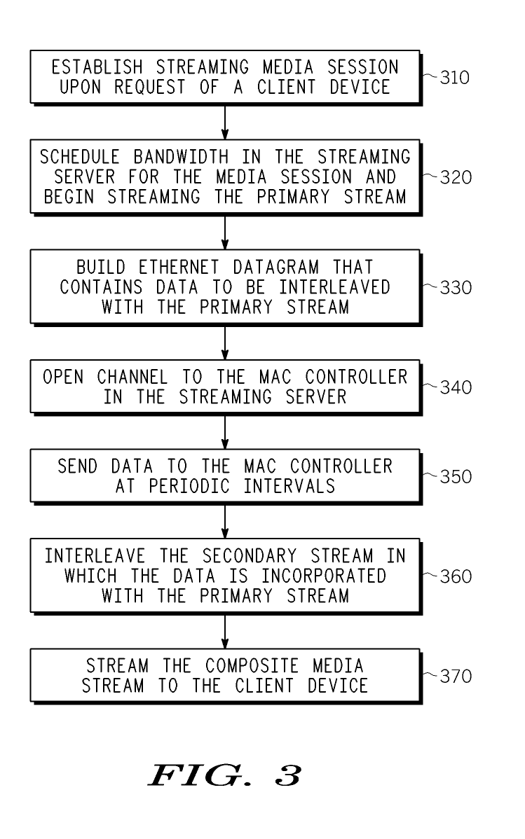

FIG. 3 shows one example of a process by which a streaming server can stream both on-demand content requested by a subscriber along with other data such as time-variant or session-variant data. The method begins in step 310 when a streaming media session is established upon the subscriber's request. The MAC controller 402 in the streaming server 100 schedules bandwidth for the session in step 320 and begins the streaming process by streaming the primary stream that contains the on-demand content. Next, in step 330 the module CPU 404 builds an Ethernet datagram that contains the data to be incorporated with the on-demand content. The module CPU 404 also opens a channel to the MAC controller in step 340 and begins sending the data at periodic intervals in step 350. The periodically transmitted data defines the secondary stream. The MAC controller 402 interleaves the secondary stream with the primary stream in step 360 to create a composite media stream. The primary stream maintains its timing information and the like that was established when the stream was created. Finally, in step 370, the composite media stream is streamed to the client device over the appropriate transport network.

The processes described above, including those shown in FIG. 3, may be implemented in a general, multi-purpose or single purpose processor. Such a processor will execute instructions, either at the assembly, compiled or machine-level, to perform that process. Those instructions can be written by one of ordinary skill in the art following the description of FIG. 3 and stored or transmitted on a computer readable medium. The instructions may also be created using source code or any other known computer-aided design tool. A computer readable medium may be any medium capable of carrying those instructions and include a CD-ROM, DVD, magnetic or other optical disc, tape, silicon memory (e.g., removable, non-removable, volatile or non-volatile), packetized or non-packetized wireline or wireless transmission signals.

Although various embodiments and examples are specifically illustrated and described herein, it will be appreciated that modifications and variations are covered by the above teachings and are within the purview of the appended claims.

1. At least one computer-readable medium encoded with instructions which, when executed by a processor, performs a method including:
(i) generating a plurality of asynchronous media streams by:
encapsulating packetized on-demand content in a first data link level format;
(ii) generating a secondary data stream by:
encapsulating packetized secondary data in the first data link level format;
(iii) periodically interleaving the secondary data stream into a selected one of the asynchronous media streams to generate a composite media stream; and
(iv) streaming the composite media stream to a client device over a transport network.

2. The computer-readable medium of claim 1 wherein the secondary data is time-variant data.

3. The computer-readable medium of claim 1 wherein the secondary data includes a cryptographic parameter needed to decrypt the on-demand content.

4. The computer-readable medium of claim 1 wherein the cryptographic parameter is included in an Encryption Control Message (ECM).

5. The computer-readable medium of claim 1 wherein the secondary data is session-dependent data.

6. The computer-readable medium of claim 1 wherein the on-demand content is pre-encrypted.

7. The computer-readable medium of claim 1 wherein the secondary data is digitally encoded and packetized by a processor that also processes control requests associated with an on-demand session and which are received from the client device over the transport network.

8. The computer-readable medium of claim 1 wherein first encoding format is MPEG.

9. The computer-readable medium of claim 1 wherein generating the plurality of asynchronous media streams further comprises
digitally encoding on-demand content in a first encoding format;
packetizing the encoded on-demand content in a first network level format;
and wherein generating the secondary data stream further comprises:
digitally encoding secondary data in the first encoding format; and
packetizing the encoded secondary data in the first network level format.

10. At least one computer-readable medium encoded with instructions which, when executed by a processor, performs a method including:
streaming a primary media stream that includes content encoded in accordance with a format that provides control information sufficient for decoding and presentation of the content;
interleaving into the primary media stream a secondary data stream in accordance with the first transport protocol stack during the on-demand session.

11. The computer-readable medium of claim 10 wherein the primary and secondary streams are packetized in accordance with a common transport protocol stack.

12. The computer-readable medium of claim 10 wherein the secondary data stream includes time-variant data.

13. The computer-readable medium of claim 10 wherein the secondary data stream includes a cryptographic parameter needed to decrypt the on-demand content.

14. The computer-readable medium of claim 13 wherein the cryptographic parameter is included in an Encryption Control Message (ECM).

15. An on-demand streaming server:
a memory array for storing on-demand content;
at least one stream server module for retrieving the content from the memory array and generating therefrom a plurality of asynchronous media streams to be transmitted to client devices in accordance with a first transport protocol stack during an on-demand session; and
wherein the stream server module includes a processor for interleaving into at least one of the asynchronous media streams a secondary data stream in accordance with the first transport protocol stack during the on-demand session.

16. The on-demand streaming server of claim 15 wherein the at least one stream server module includes a plurality of stream server modules and further comprising an interconnect for controlling transfer of data between the memory array and the stream server modules.

17. The on-demand streaming server of claim 15 wherein the secondary data stream includes time-variant data.

18. The on-demand streaming server of claim 15 wherein the secondary data stream includes a cryptographic parameter needed to decrypt the on-demand content.

19. The on-demand streaming server of claim 18 wherein the cryptographic parameter is included in an Encryption Control Message (ECM).
